(19) United States
(12) Patent Application Publication
(10) Pub. No.: US 2008/0139231 A1
(43) Pub. Date: Jun. 12, 2008

(54) METHOD AND SYSTEM FOR SPECTRUM REUSE IN THE DOWNLINK IN A WIRELESS COMMUNICATION NETWORK

(76) Inventors: Rehan Jalil, San Jose, CA (US); Mustafa Ergen, Oakland, CA (US); Tony Mak, St. San Francisco, CA (US)

Correspondence Address: Global IP Services, PLLC, 198 F, 27th Ctoss, 3rd Block, Jayanagar-Bangalore, Karnataka, 560011, omitted

(21) Appl. No.: 11/951,346

(22) Filed: Dec. 6, 2007

Related U.S. Application Data
(60) Provisional application No. 60/873,725, filed on Dec. 7, 2006.

(51) Int. Cl. H04Q 7/20; H04L 27/28

(52) U.S. Cl. 455/509; 375/260

(57) ABSTRACT

A method and system for managing communication in a wireless communication network is provided. The wireless communication network includes a plurality of Base Stations (BS). Each BS provides communication to one or more Mobile Station (MS) in an associated cell. The method includes reusing at a BS one or more parts of one or more frequency bands at a predetermined power level. A frequency band that is reused is allocated to a collocated BS. The method further includes receiving interference information corresponding to one or more of a cell of the BS and one or more collocated cells. A collocated cell is associated with a collocated BS. Additionally, the method includes varying the predetermined power level based on the interference information received.

### RELATED APPLICATIONS

Benefit is claimed under 35 U.S.C. 119(e) to U.S. Provisional Applications Ser. 60/873,725, entitled “Adaptive method to minimize interference for spectrum reuse in the downlink” by Mustafa Ergen et al., filed on Dec. 7, 2006 which is herein incorporated in its entirety by reference for all purposes.

### FIELD OF THE INVENTION

Generally the invention relates to wireless communication networks. More specifically, the invention relates to a method and system for managing communication in wireless communication networks.

### BACKGROUND OF THE INVENTION

In a wireless communication network, in order to ensure complete spatial coverage over a geographical area, Base Stations (BSs) are positioned and operated in such a way that collocated cells, corresponding to collocated BSs, overlap each other. However, due to overlapping of collocated cells, corresponding collocated BSs are allocated different frequency bands for downlink transmission to avoid co-channel interference in Mobile Stations (MSs) located in regions where collocated cells overlap. Thus, each BS utilizes only a part of a total frequency bandwidth available in the wireless communication network. This results in inefficient utilization of the total frequency bandwidth among collocated BSs.

One method of improving efficiency of utilization of the total frequency bandwidth among collocated BSs is to reuse frequency bands among collocated BSs. In this method, each BS is allocated a frequency band for downlink transmission which is different from each frequency band allocated to collocated BSs. Additionally, each BS reuses frequency bands allocated to a collocated BS. However, to avoid co-channel interference in a MS, served by a BS, which is located in a region where a coverage area corresponding to a frequency band allocated to a collocated BS overlaps with a coverage area corresponding to frequency bands that are reused at the BS, a power level of the frequency bands that are reused at the BS is maintained lesser than a power level of the frequency band allocated to the collocated BS. As a result, coverage areas corresponding to the frequency bands that are reused are smaller in comparison to coverage areas corresponding to the frequency band allocated to the collocated BSs.

If power level of the frequency bands that are reused at the BS is equal to or greater than the power level of the frequency band allocated to the collocated BS, coverage areas corresponding to the frequency bands that are reused at the BS would overlap with coverage areas corresponding to the frequency band allocated to the collocated BS. Since one or more frequencies are common between the frequency bands that are reused at the BS and the frequency band allocated to the collocated BS, co-channel interference will arise in MSs located in regions where coverage areas corresponding to the frequency bands that are reused at the BS would overlap with coverage areas corresponding to the frequency band allocated to the collocated BS. Therefore, to reuse frequency bands among collocated BSs without causing co-channel interference in MSs, power level of the frequency bands that are reused at a BS must be maintained lesser than power level of a frequency band allocated to a collocated BS.

However, lesser power levels of the frequency bands that are reused result in lesser coverage areas corresponding to the frequency bands that are reused, and consequently, lesser number of MSs being served with the frequency bands that are reused.

Therefore, there is a need of a method and system, which reuses frequency bands efficiently.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a wireless communication network (that is exemplary) in which various embodiments of the invention may function.

FIG. 2 illustrates a flow diagram of a method for managing communications in a wireless communication network, in accordance with an embodiment of the invention.

FIG. 3 illustrates a flow diagram of a method of determining the predetermined power level for reusing one or more parts of frequency bands allocated to collocated BSs, in accordance with an embodiment of the invention

FIG. 4 illustrates a flow diagram of a method of determining the predetermined power level for reusing one or more parts of frequency bands allocated to collocated BSs, in accordance with another embodiment of the invention

FIG. 5 illustrates a flow diagram of a method of determining the predetermined power level for reusing one or more parts of frequency bands allocated to collocated BSs, in accordance with another embodiment of the invention.

FIG. 6 illustrates a method of reusing one or more parts of one or more frequency bands in a wireless communication network, in accordance with an exemplary embodiment of the invention.

FIG. 7 illustrates a block diagram of a BS for managing communication in a wireless communication network, in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to method and system for managing communication in a wireless communication network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the present invention described herein may be comprised of one or more conventional transaction-clients and unique stored program instructions that control the one or more transaction-clients to implement, in conjunction with certain non-transaction-client circuits, some, most, or all of the functions of a method for managing communication in a wireless communication network. The non-transaction-client circuits may include, but are not limited to, a radio receiver, a radio transmitter, signal drivers, clock circuits, power source circuits, and user input devices. As such, these functions may be interpreted as steps of methods for managing communication in a wireless communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Various embodiments of the invention provide methods and system for managing communication in a wireless communication network. At each BS in the wireless communication network, a power level of one or more parts of one or more frequency bands that are reused is dynamically and adaptively varied in order to minimize interference induced due to reuse. A BS receives interference information corresponding to one or more of a cell of the BS and one or more collocated cells. Based on the interference information, power level of one or more parts of frequency bands being reused at the BS is varied to maximize the corresponding coverage areas of the frequency bands being reused while minimizing interference induced by the reuse.

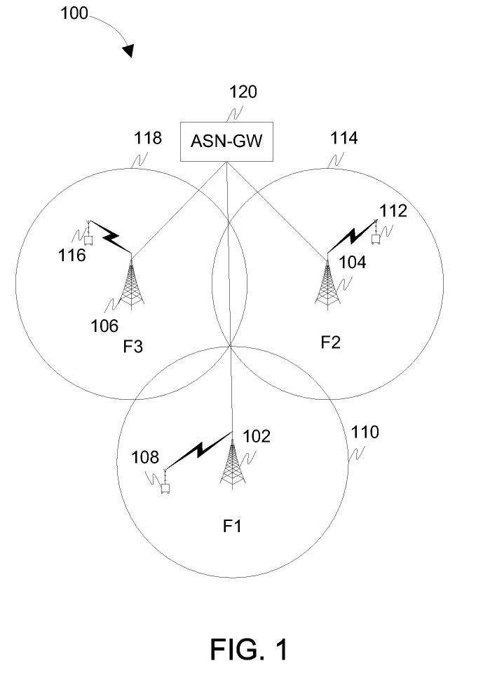

FIG. 1 is a block diagram illustrating a wireless communication network (that is exemplary) 100 in which various embodiments of the invention may function. Wireless communication network 100 may be one of, but is not limited to WiMAX, 3GPP LTE, 3GPP2 UMB and any OFDMA variant system. In an embodiment, wireless communication network may be a Multiple Input Multiple Output (MIMO) communication network. Wireless communication network 100 includes a Base Station (BS) 102, a BS 104, and a BS 106. It will be apparent to a person skilled in the art that wireless communication network 100 may include more than three BSs. BS 102 is collocated with BS 104 and BS 106. In other words, each of BS 104 and BS 106 is a collocated BS of BS 102. Similarly, BS 104 is collocated with BS 106. BS 102 provides communication services to one or more MSs (for example, MS 108) located within a cell 110 of BS 102. Similarly, BS 104 provides communication services to one or more MSs (for example, MS 112) located within a cell 114 of BS 104, and BS 106 provides communication services to one or more MSs (for example, MS 116) located within a cell 118 of BS 106. In order to ensure complete spatial coverage of regions between collocated BSs, i.e., BS 102, BS 104, and BS 106, cell 110, cell 114, and cell 118 overlap each other. Additionally, wireless communication network 100 includes an Access Service Network Gateway (ASN-GW) 120, which communicates with each of BS 102, BS 104, and BS 106. ASN-GW 120 also acts as a central controller that allocates a frequency band to each of BS 102, BS 104, and BS 106. It will be apparent to a person skilled in the art that a central controller (not shown in FIG. 1) may be a system entity outside ASN-GW 120.

Each of BS 102, BS 104, and BS 106 is allocated a frequency band for downlink transmission to provide communication services to one or more MSs located within an associated cell. BS 102 is allocated a frequency band F1 for downlink transmission. Similarly, BS 104 is allocated a frequency band F2, and BS 106 is allocated a frequency band F3. A frequency band allocated to a BS in wireless communication network 100 is different from frequency bands allocated to collocated BSs in wireless communication network 100. This avoids co-channel interference in MSs located in regions where collocated cells overlap.

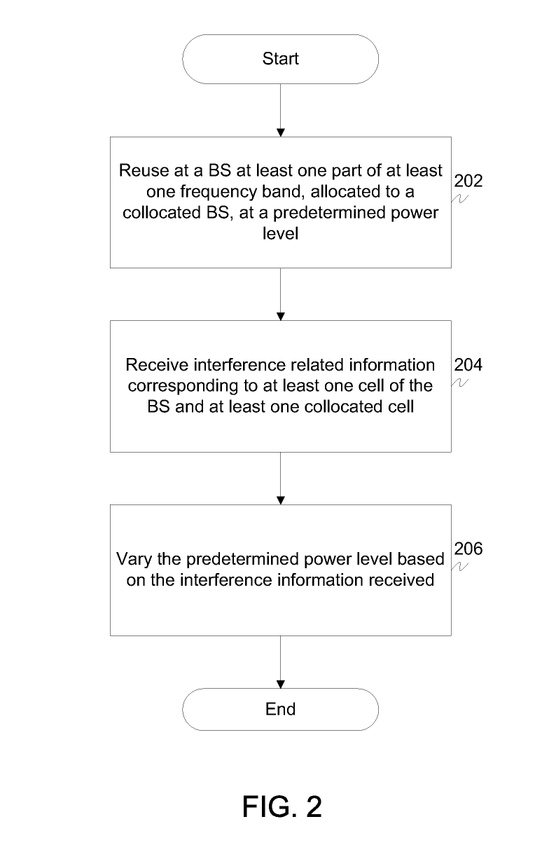

FIG. 2 illustrates a flow diagram of a method for managing communications in a wireless communication network 100, in accordance with an embodiment of the invention. At step 202, at a BS, one or more parts of one or more frequency bands are reused at a predetermined power level. A frequency band allocated to a collocated BS is reused at the BS. For example, frequency band F2 and frequency band F3 may be reused at BS 102 at a predetermined power level. By way of another example, one or more parts of frequency band F2 may be reused at BS 102 at a predetermined power level.

Re-using one or more parts of one or more frequency bands allocated to collocated BSs at the predetermined power level confines their coverage area at the BS to an inner cell. The radius of the inner cell is a fraction of the radius of the cell of the BS. For example, the inner cell may be a concentric circle of half the radius of the cell of the BS. One or more parts of a frequency band that is reused, are used to serve MSs in the inner cell and a frequency band allocated to the BS is used to serve MSs in the cell of the BS, including the inner cell. For example, at BS 102, frequency band F2 may be used to serve MSs in an inner cell within cell 110, and frequency band F1 allocated to BS 102 may be used to serve MSs in cell 110, including the inner cell. In an embodiment of the invention, one or more parts of a frequency band that are reused, are used to serve MSs in the inner cell and a frequency band allocated to the BS is used to serve MSs located in a region between boundary of the inner cell and boundary of the cell of the BS. For example, at BS 102, frequency band F3 may be used to serve MSs in an inner cell within cell 110, and frequency band F1 may be used to serve a second set of MSs in a region between boundary of the inner cell in cell 114 and boundary of cell 114. Therefore, as a consequence of reusing one or more parts of frequency bands allocated to collocated BSs at the BS, the BS is able to serve an increased number of MSs.

The number of MSs served by the BS by reusing one or more parts of one or more frequency bands depends on each of a number of frequency bands being reused at the BS and the radius of the inner cell. For a fixed number of frequency bands reused at the BS, the number of MSs served by the BS depends on radius of the inner cell. The radius of the inner cell further depends on the predetermined power level of one or more parts of one or more frequency bands being reused at the BS.

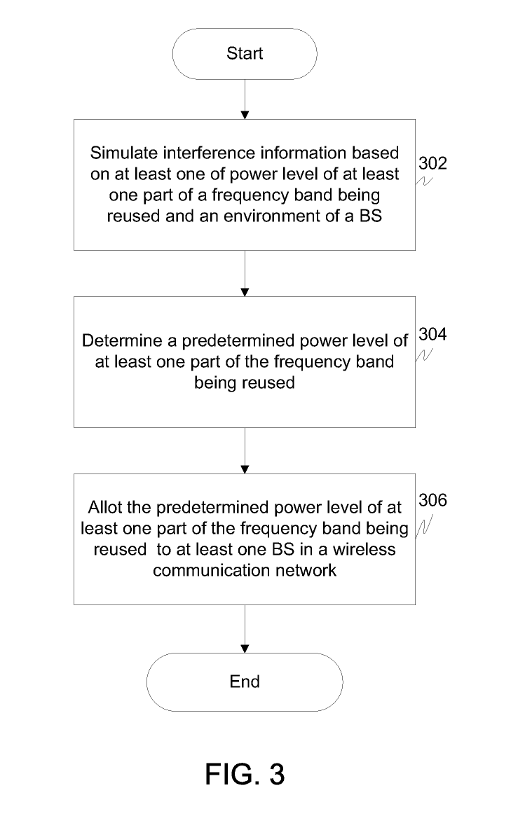

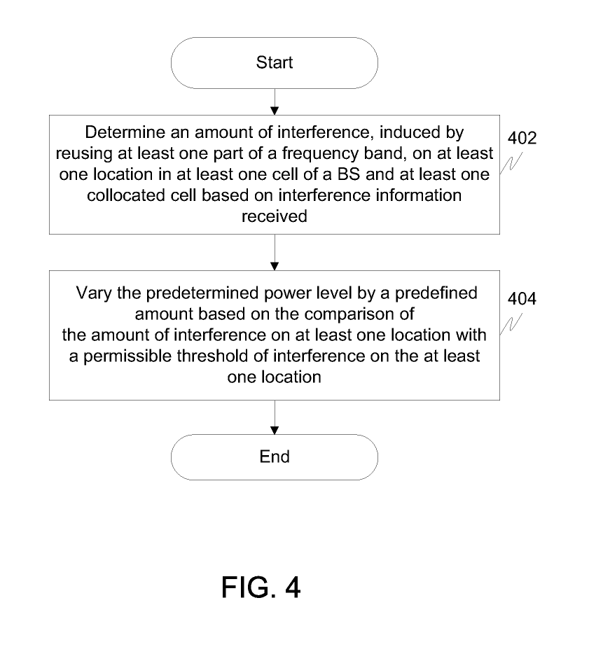

The predetermined power level may be increased to increase the number of MSs served by the BS. However, the predetermined power level cannot be increased without limit as this would lead to co-channel interference in MSs in collocated cells. A method of determining the predetermined power level BS is explained in detail in conjunction with FIG. 3 and FIG. 4.

Thereafter, at step 204, the BS receives interference information corresponding to one or more of a cell of the BS and one or more collocated cells. For example, BS 102 receives interference information corresponding to cell 110 of BS 102 and collocated cells, i.e., cell 114 and cell 118. The interference information received corresponding to a location represents co-channel interference induced by reusing one or more parts of one or more frequency bands at the location. The interference information received may be embedded in at least one of a Carrier to Interference-plus-Noise Ratio (CINR) message, a Received Signal Strength Indicator (RSSI) message, and a Signal to Interference-plus-Noise Ratio (SINR) message, and packet error rate. Interference information corresponding to the cell of the BS is received from MSs served by the BS. For example, BS 102 may receive interference information for a location in cell 110 from MS 108 present at the location. Additionally, the BS receives interference information corresponding to a collocated cell from a collocated BS in the collocated cell. The interference information received from a collocated BS for a location in a collocated cell represents co-channel interference at the location induced in a MS served by the collocated BS. The co-channel interference is induced in the MS, as a result of the reuse of a frequency band allocated to the collocated BS, at the BS. In another embodiment of the invention, the interference information is received from detectors installed in one or more of the cell of the BS and one or more collocated cells.

The BS may receive interference information periodically after a predetermined time period. For example, BS 102 may receive the interference information periodically from MS 108 in cell 110 and from each of BS 104 and BS 106 after a predetermined time period. Alternatively, the interference information is received in response to a request initiated by the BS. For example, BS 102 may initiate a request to each of MS 108, BS 104, and BS 106 to receive corresponding interference information. In response to the request, BS 102 receives the interference information from each of MS 108, BS 104, and BS 106.

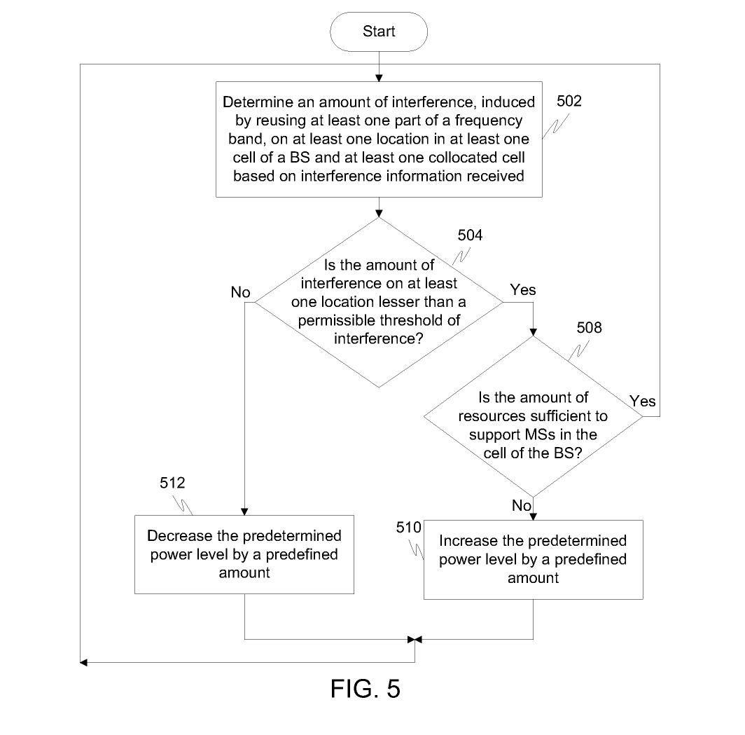

At step 206, the predetermined power level at the BS is varied based on the interference information received. The predetermined power level at a BS may be varied by using simulation. This is further explained in detail in conjunction with FIG. 3. Alternatively, the predetermined power level at a BS may be varied dynamically. This is further explained in detail in conjunction with FIG. 4 and FIG. 5. For example, BS 102 varies the predetermined power level based on the interference information received from each of MS 108, BS 104, and BS 106. The interference information represents co-channel interference induced by reusing one or more parts of one or more frequency bands. Further, co-channel interference depends on the predetermined power level of one or more parts of one or more frequency bands reused. Therefore, by varying the predetermined power level based on the interference information, co-channel interference experienced by MSs in collocated cells due to reuse of one or more parts of frequency bands allocated to collocated cells can be minimized. Additionally, by varying the predetermined power level, radius of the inner cell can be varied. Consequently, by increasing the predetermined power level radius of the inner cell, and hence the number of MSs served in the inner cell may be increased. Therefore, by varying the predetermined power level based on the interference information received, the number of MSs served by reusing one or more parts of one or more frequency bands can be maximized without inducing unacceptable co-channel interference in MSs served by collocated BSs. This is explained in detail in conjunction with FIG. 4 and FIG. 5.

FIG. 3 illustrates a flow diagram of a method of determining the predetermined power level for reusing one or more parts of frequency bands allocated to collocated BSs, in accordance with an embodiment of the invention. At step 302, ASN-GW 120 simulates interference information based on one or more of power levels of one or more parts of one or more frequency bands that are reused and an environment of the BS. In an embodiment, interference information may be simulated by a system entity, which is not a part of wireless communication network 100. Examples of environments of a BS may include but are not limited to dense environment and spread out environment. In a simulation, a set of BSs may reuse frequency bands allocated to all collocated BSs, while another set of BSs may reuse frequency bands allocated only to some of the collocated BSs. For example, in order to maximize the number of MSs served in a preferential cell, frequency bands allocated to all collocated cells may be reused in the preferential cell. However, collocated cells of the preferential cell may not reuse the frequency band allocated to the preferential cell in order to avoid interference to MSs in the preferential cell due to reusing frequency bands. The preferential cell may correspond to a region consisting of statistically high density of MSs.

In an embodiment, in a simulation, power level of frequency bands reused at a set of BSs may be different from power level of frequency bands reused at another set of BSs. For example, power level of frequency bands reused at BSs whose local environment is dense would be lesser than power level of frequency bands reused at BSs whose local environment is spread-out. In another embodiment, in a simulation, power level of a frequency band reused at a BS may be different from power level of another frequency band reused at the BS. For example, consider a BS whose local environment consists of a first collocated BS which overlaps with the cell of the BS and a second collocated BS which does not overlap with the cell of the BS. The power level for reusing frequency band allocated to the first collocated BS may be lesser than a power level for reusing frequency band allocated to the second collocated BS.

Thereafter, based on the interference information simulated, ASN-GW 120 selects an acceptable power level to be the predetermined power level of one or more parts of one or more frequency bands that are reused. In an embodiment, a BS may select the acceptable power level. An acceptable power level is one which does not induce co-channel interference above a permissible limit in one or more of the cell corresponding to the BS and one or more collocated cells. To confirm acceptability of the predetermined power level, ASN-GW 120 may obtain interference information by taking actual measurements from one or more of a cell of the BS and collocated cells. In an embodiment, the BS may obtain the interference information.

At step 306, ASN-GW 120 allocates the predetermined power level to one or more BSs in wireless communication network 100 to reuse one or more parts of frequency bands allocated to collocated BSs. In an embodiment of the invention, ASN-GW 120 allocates the predetermined power level to each BS in wireless communication network 100. In another embodiment of the invention, ASN-GW 120 allocates the predetermined power level to a BS based on an environment of the BS. For example, if the predetermined power level is determined by simulating interference information for a BS situated in a spread out environment, the predetermined power level is allocated to each BS situated in the spread-out environment in wireless communication network 100. The above method of determining the predetermined power level is suitable where a number of BSs are located in a uniform environment because, the predetermined power level determined from a single simulation is assigned to a each BS in wireless communication network 100. In an embodiment of the invention, a BS may allocate the predetermined power level to the BS itself.

FIG. 4 illustrates a flow diagram of a method of determining the predetermined power level for reusing one or more parts of frequency bands allocated to collocated BSs, in accordance with another embodiment of the invention. At step 402, an amount of interference, which is induced by reusing one or more frequency bands allocated to collocated BSs, at one or more locations in one or more of the cell of the BS and one or more collocated cells, is determined based on the interference information received at the BS. The interference information may be received from one or more of collocated BSs and detectors installed in one or more of the cell of the BS and collocated cells. For example, based on the interference information received at BS 102, an amount of interference induced in each of cell 110, cell 114, and cell 118 by reusing one or more parts of frequency bands allocated to collocated BSs at BS 102 is determined.

At step 404, the predetermined power level is varied by a predefined amount based on the comparison of the amount of interference at one or more locations induced by reusing one or more parts of one or more frequency bands and a permissible threshold limit of interference. In effect, the method monitors the amount of interference induced by reusing one or more parts of one or more frequency bands at the BS, and varies the predetermined power level of in order to maintain the amount of interference at one or more locations below a permissible threshold limit. Additionally, the method varies the predetermined power level in order to increase radius of the inner cell of the BS, while maintaining the amount of interference at one or more locations in one or more of the cell and collocated cells below a permissible threshold limit. In an embodiment of the invention, the predetermined power level is varied based on a result of an analysis of the interference information.

In another embodiment of the invention, the predetermined power level of one or more parts of a frequency band is varied based on the number of MSs located in regions where the inner cell of the BS overlaps with collocated cells. An MS in a region where the inner cell of the BS overlaps with collocated cells may be served by the BS or by a collocated BS. For example, if there are no MSs served by a collocated BS, in regions where the cell of the BS overlaps with collocated cells, then the predetermined power level for reusing one or more parts of a frequency band allocated to the collocated BS may be increased to cover the overlapping region with the collocated cell to serve more MSs by the BS.

FIG. 5 illustrates a flow diagram of a method of determining the predetermined power level for reusing one or more parts of frequency bands allocated to collocated BSs, in accordance with another embodiment of the invention. At step 502, an amount of interference at one or more locations in one or more of the cell of the BS and one or more collocated cells induced by reusing one or more parts of one or more frequency bands is determined based on the interference information received at the BS. The interference information may be received from one or more of collocated BSs and detectors installed in one or more of the cell of the BS and one or more collocated cells. At step 504, the amount of interference at one or more locations is compared with a permissible threshold of interference at one or more locations. If the amount of interference at one or more locations is lesser than the permissible threshold of interference at one or more locations, then at step 508, a check is performed to determine if the resources to support MSs in the cell of the BS are sufficient or not. If the resources to support MSs in the cell of the BS are not sufficient then, at step 510, the predetermined power level is increased by a predefined amount. Thereafter, step 502 to step 504 are repeated.

Referring back to step 504, if the amount of interference at one or more locations is greater than the permissible threshold of interference, then at step 512, the predetermined power level is decreased by a predefined amount. Thereafter, step 502 to step 504 are repeated. Therefore, power level of one or more parts of one or more frequency bands that are reused is continuously varied based on the amount of interference induced at one or more locations by reusing frequency bands. An advantage of the method is that dynamic and adaptive variation of the predetermined power level maximizes radius of the inner cell of the BS while minimizing the amount of interference induced to MSs in collocated cells by reusing one or more part of one or more frequency bands. Therefore, the number of MSs served by the BS is maximized while ensuring minimum interference to MSs served by collocated BSs.

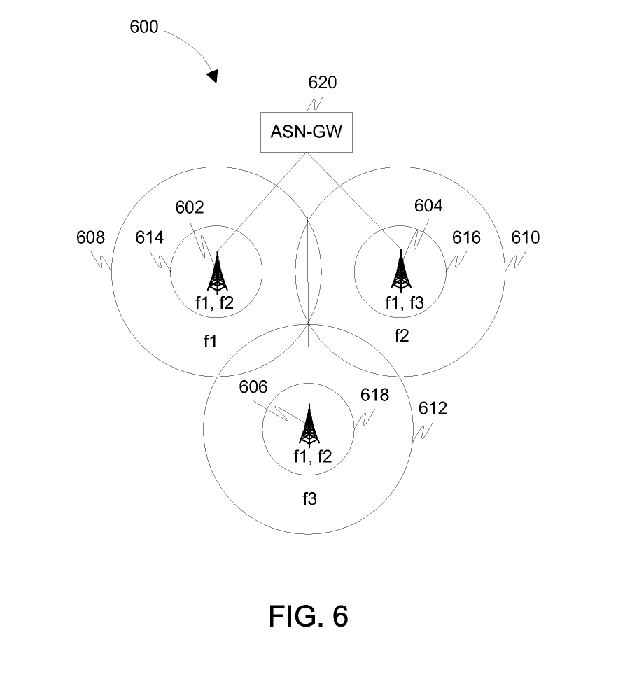

FIG. 6 illustrates a method of reusing one or more parts of one or more frequency bands in a wireless communication network 600, in accordance with an exemplary embodiment of the invention. Wireless communication network 600 includes BS 602, BS 604, and BS 606. It will be apparent to one skilled in the art that wireless communication network 600 may include more than three BSs. BS 602 is collocated with BS 604 and BS 606. Similarly, BS 604 is collocated with BS 606. Each of BS 602, BS 604, and BS 606 is allocated a frequency band for providing communication services to one or more MSs located within an associated cell. BS 602 provides communication services to MSs in a cell 608. Similarly, BS 604 provides communication services to MSs in a cell 610 and BS 606 in a cell 612. In order to ensure complete spatial coverage in wireless communication network 600, cell 608 overlaps with each of cell 610 and cell 612, and cell 608 overlaps with cell 612. Additionally, wireless communication network 600 includes an Access Service Network Gateway (ASN-GW) 620, which communicates with each of BS 602, BS 604, and BS 606. ASN-GW 620 also acts as a central controller that allocates a frequency band to each of BS 602, BS 604, and BS 606. It will be apparent to a person skilled in the art that a central controller (not shown in FIG. 6) may be a system entity outside ASN-GW 620.

BS 602 is allocated a frequency band f1 for downlink transmission. Similarly, BS 604 is allocated a frequency band f2 and BS 606 is allocated a frequency band f3. A frequency band allocated to each of BS 602, BS 604, and BS 606 is different from a frequency band allocated to a collocated BS. Additionally, at each of BS 602, BS 604 and BS 606, frequency bands allocated to collocated BSs are reused. In other words, BS 602 reuses the frequency band f2 and the frequency band f3. Similarly, BS 604 reuses the frequency band f1 and the frequency band f3, and BS 606 reuses the frequency band f1 and the frequency band f2.

BS 602 provides communication services to MSs located in an inner cell 614 by reusing the frequency band f2 and the frequency band f3 at a predetermined power level. Similarly, BS 604 serves MSs located in an inner cell 616 reusing the frequency band f1 and the frequency band f3 at a predetermined power level. Likewise, BS 606 serves MSs located in an inner cell 618 reusing the frequency band f1 and the frequency band f2 at a predetermined power level. Additionally, BS 602 provides communication services to MSs located outside inner cell 614 and inside the boundary of cell 608 using the frequency band f1. Also, BS 604 provides communication services to MSs located outside inner cell 616 and inside the boundary of cell 610 using the frequency band f2. Similarly, BS 606 provides communication services to MSs located outside inner cell 618 and inside the boundary of cell 612 using the frequency band f3. A predetermined power level of frequency bands that are reused at each of BS 602, BS 604 and BS 606 is lesser than a power level of a frequency band allocated to each of BS 602, BS 604 and BS 606. For instance, at BS 602, the predetermined power level of the frequency band f2 is less than a power level of the frequency band f1. Therefore, the radius of inner cell 614 is less than the radius of cell 608. Similarly, for BS 604 the radius of inner cell 616 is less than the radius of cell 610 and for BS 606 the radius of inner cell 618 is less than the radius of cell 612.

BS 602 receives interference information corresponding to cell 608 and interference information corresponding to each of cell 610 and cell 612. The interference information corresponding to cell 608 is received from MSs served by BS 602 and interference information for cell 610 is received from BS 604 and for cell 612 is received from BS 606. Similarly, each of BS 604 and BS 606 receive interference information.

Based on the interference information received at BS 602, an amount of interference at one or more locations in cell 608, cell 610 and cell 612, induced by reusing one or more parts of the frequency band f2 and the frequency band f3 is determined. The amount of interference in at one or more locations is cell 610 and cell 612 represents co-channel interference experienced by MSs served by BS 604 and BS 606. The amount of interference at one or more locations is compared with a permissible threshold limit corresponding to one or more locations. If the amount of interference at one or more locations is above a permissible threshold limit for one or more locations, then the predetermined power level of the frequency band f2 and the frequency band f3 at BS 602 is decreased by a predefined amount. Thereafter, after a predetermined period of time, interference information is again received at BS 602 and the predetermined power level is varied based on the interference information received.

However, if the amount of interference at one or more locations is below a permissible threshold limit for one or more locations, then the predetermined power level of the frequency band f2 and the frequency band f3 at BS 602 is increased by a predefined amount. Therefore, by varying the predetermined power level for reusing the frequency band f2 and the frequency band f3 at BS 602, based on the interference information induced received at BS 602, the predetermined power level is maximized while maintaining an amount of interference induced by reusing the frequency band f1 and the frequency band f2 below a permissible threshold limit. Similarly, interference information is received at BS 604 and BS 606. Based on the interference information received at BS 604, the predetermined power level for reusing the frequency band f1 and the frequency band f3 at BS 604 is varied. Similarly, based on the interference information received at BS 606, the predetermined power level for reusing the frequency band f1 and the frequency band f2 at BS 606 is varied.

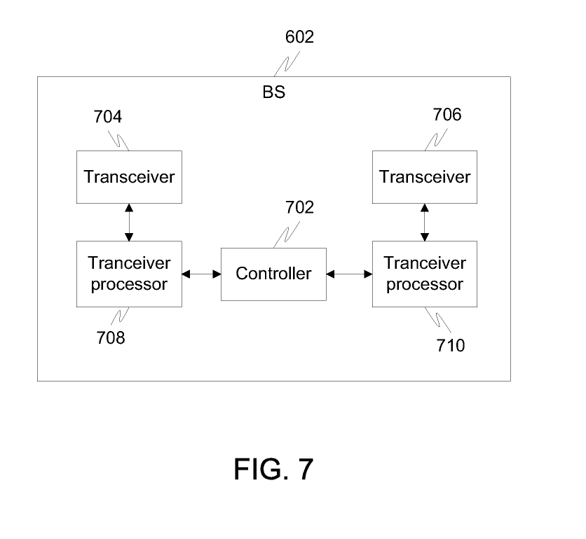

FIG. 7 illustrates a block diagram of BS 602 for managing communication in wireless communication network 600, in accordance with an embodiment of the invention. BS 602 includes a controller 702, one or more transceivers (for example, transceiver 704 and transceiver 706), and one or more transceiver processors (for example, a transceiver processor 708 and a transceiver processor 710). Each transceiver processor is adaptively couple to a transceiver and controller 702. For example, transceiver processor 708 is adaptively coupled to transceiver 704 and transceiver processor 710 is adaptively coupled to transceiver 706. Though not shown, it will be apparent to a person skilled in the art that each of BS 604 and BS 606 has its own controller, one or more transceivers, and one or more transceiver processors.

Further, each transceiver of BS 602 may be an adaptive antenna. Therefore, each transceiver can use beamforming to adjust the angle and width of transmission from it to a receiver in wireless communication network 600. In an embodiment, cell 608 is divided into one or more sectors. MSs in a sector are served by a transceiver of BS 602. Therefore, the number of sectors of cell 602 is equal to the number of transceivers in BS 602. For example, if cell 602 is divided into two sectors, then transceiver 704 is used to serve MSs in a first sector and transceiver 706 is used to serve MSs in a second sector.

Controller 702 reuses at BS 602 one or more parts of one or more frequency bands at a predetermined power level. A frequency band that is reused is allocated to a collocated BS (for example, BS 604). Each transceiver receives interference information corresponding to one or more of a cell of BS 602 and one or more collocated cells. For example, transceiver 704 receives interference information corresponding to each of cell 608, cell 610 and cell 612. Transceiver 704 may receive the interference information from one or more of BS 604, BS 606, and MSs located in cell 608. Alternatively, transceiver 704 may receive the interference information from one or more detectors installed in one or more of cell 608, cell 610, and 612. The interference information corresponding to a collocated cell is received from a collocated BS in the collocated cell. This has been explained in detail in conjunction with FIG. 2, and FIG. 4.

Thereafter, each transceiver processor determines the amount of interference at one or more locations in one or more of cell 608, cell 610, and cell 612 induced by reusing one or more parts of one or more frequency bands. Each transceiver processor determines the amount of interference induced based on the interference information received. Thereafter, each transceiver processor varies the predetermined power level based on the interference information received. Alternatively, controller 702 may instruct each transceiver processor to vary the predetermined power level. In an embodiment, a transceiver processor varies the predetermined power level by a predefined amount based on the comparison of the amount of interference on one or more locations induced by reusing one or more parts of one or more frequency bands and a permissible threshold limit of interference at one or more locations. This has been explained in detail in conjunction with FIG. 4 and FIG. 5.

Various embodiments of the invention provide methods and systems for determining power level for reusing one or more parts of frequency bands allocated to collocated BSs based on interference information. Reusing one or more parts of the frequency bands leads to an efficient of utilization of frequencies in a wireless communication network. Additionally, a number of MSs served by a BS can be maximized while minimizing interference to MSs served by collocated BSs, which is induced by reusing frequency band allocated to the collocated BSs. In this method, a reuse factor of 1 is achieved in the wireless communication network.

Those skilled in the art will realize that the above recognized advantages and other advantages described herein are merely exemplary and are not meant to be a complete rendering of all of the advantages of the various embodiments of the invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. In a wireless communication network having a plurality of Base Stations (BS), each BS providing communication to at least one Mobile Station (MS) in an associated cell, a method of managing communication in the wireless communication network, the method comprising:
reusing at a BS at least one part of at least one frequency band at a predetermined power level, wherein a frequency band being reused is allocated to a collocated BS;
receiving interference information corresponding to at least one of a cell of the BS and at least one collocated cell, wherein a collocated cell is associated with a collocated BS; and
varying the predetermined power level based on the interference information received.

2. The method of claim 1, wherein the interference information corresponding to the cell of the BS is received from MSs served by the BS.

3. The method of claim 1, wherein information corresponding to a collocated cell is received from a collocated BS in the collocated cell.

4. The method of claim 1, wherein the interference information is received from detectors installed in at least one of the cell of the BS and the at least one collocated cell.

5. The method of claim 1, wherein the interference information is received periodically after a predetermined time period.

6. The method of claim 1, wherein the interference information is received in response to a request initiated by the BS.

7. The method of claim 1, wherein the predetermined power level for reusing at least one part of a frequency band is determined by simulating interference information based on at least one of power-level of at least a part of the frequency band being reused and an environment of the BS.

8. The method of claim 7, wherein the predetermined power-level determined for at least one part of the frequency band being reused is allocated to each BS in the wireless communication network.

9. The method of claim 7, wherein the predetermined power-level of at least one part of the frequency band being reused is allocated to a BS based on an environment of the BS.

10. The method of claim 1, wherein varying the predetermined power-level comprises determining the amount of interference on at least one location in at least one of the cell of the BS and at least one collocated cell induced by reusing at least one part of a frequency band, wherein the amount of interference induced is determined based on the interference information received.

11. The method of claim 10, wherein the predetermined power level is varied by a predefined amount based on the comparison of the amount of interference on the at least one location induced by reusing at least one part of the frequency band and a permissible threshold limit of interference at the at least one location.

12. The method of claim 11, wherein the predetermined power level is increased by the predefined amount, if the amount of interference on at least one location induced by reusing at least one part of the frequency band is below the permissible threshold limit.

13. The method of claim 11, wherein the predetermined power level is decreased by the predefined amount, if the amount of interference on the at least one location induced by reusing at least one part of the frequency band is above the permissible threshold limit.

14. The method of claim 1, wherein the interference information received may be embedded in at least one of a Carrier to Interference-plus-Noise Ratio (CINR) message, a Received Signal Strength Indicator (RSSI) message, and a Signal to Interference-plus-Noise Ratio (SINR) message, and packet error rate.

15. The method of claim 1, wherein the predetermined power level assigned to reuse at least one part of a frequency band at the BS confines the coverage area of the at least one part of the frequency band being reused to an inner cell, wherein the radius of the inner cell is a fraction of the radius of the cell of the BS.

16. The method of claim 15, wherein at least one part of a frequency band being reused is used to serve MSs in the inner cell and a frequency band allocated to the BS is used to serve MSs in a region between a boundary of the inner cell and the cell of the BS.

17. The method of claim 15, wherein at least one part of a frequency band being reused is used to serve MSs in the inner cell and a frequency band allocated to the BS is used to serve MSs in the cell of the BS including the inner cell.

18. The method of claim 1, wherein the wireless communication network is a Multiple Input Multiple Output (MIMO) communication network.

19. A Base Station (BS) in a wireless communication network, the BS comprising:
a controller configured to reuse at the BS at least one part of at least one frequency band at a predetermined power level, wherein a frequency band being reused is allocated to a collocated BS;
at least one transceiver adaptively coupled to the controller, wherein each transceiver is configured to receive interference information corresponding to at least one of a cell of the BS and at least one collocated cell, wherein a collocated cell is associated with a collocated BS; and
at least one transceiver processor adaptively coupled to the at least one transceiver and the controller, wherein each transceiver processor is configured to vary the predetermined power level based on the interference information received.

20. The BS of claim 19, wherein the interference information corresponding to the cell of the BS is received from MSs served by the BS.

21. The BS of claim 19, wherein information corresponding to a collocated cell is received from a collocated BS in the collocated cell.

22. The BS of claim 19, wherein a transceiver processor is further configured to determine the amount of interference on at least one location in at least one of the cell of the BS and at least one collocated cell induced by reusing at least one part of a frequency band, wherein the transceiver processor determines the amount of interference induced based on the interference information received.

23. The BS of claim 22, wherein a transceiver processor is further configured to vary the predetermined power level by a predefined amount based on the comparison of the amount of interference on the at least one location induced by reusing at least one part of a frequency band and a permissible threshold limit of interference at the at least one location.

24. The BS of claim 19, wherein a transceiver in the BS serves MSs in a sector of the cell of the BS.

25. The BS of claim 19, wherein each transceiver is an Adaptive Antenna (AA).
